(19) United States
(12) Patent Application Publication
(10) Pub. No.: US 2026/0191240 A1
(43) Pub. Date: Jul. 9, 2026

(54) READY-TO-EAT PROTEIN FORTIFIED CEREAL

(71) Applicant: GENERAL MILLS, INC., Minneapolis, MN (US)

(72) Inventors: Claire RANDOLPH, Robbinsdale, MN (US); Obediah COOPER, Coon Rapids, MN (US); Robert J. HARRISON, Nowthen, MN (US); Michelle MANDERFELD, Plymouth, MN (US); Reed TAYLOR, Brooklyn Park, MN (US); Goeran WALTHER, Plymouth, MN (US)

(73) Assignee: GENERAL MILLS, INC., Minneapolis, MN (US)

(21) Appl. No.: 19/132,935

(22) PCT Filed: Dec. 12, 2023
(86) PCT No.: PCT/US2023/083524

§ 371 Date: May 27, 2025

Related U.S. Application Data
(60) Provisional application No. 63/432,743, filed on Dec. 15, 2022.
(60) Provisional application No. 63/458,071, filed on Apr. 7, 2023.

(51) Int. Cl. A23L 7/117; A23L 33/185; A23L 33/22; A23P 10/25

(52) U.S. Cl. CPC A23L 7/117; A23L 33/185; A23L 33/22; A23P 10/25

(57) ABSTRACT

A ready-to-eat breakfast cereal includes a plurality of base cereal pieces fortified with high quality protein. The base cereal pieces consist of a starch-based ingredient, a protein ingredient component, oil and optionally a bran ingredient or other ingredients, but no added gums. The protein ingredient component includes wheat protein isolate or vital wheat gluten, as well as legume protein concentrate or legume protein isolate. A method of making ready-to-eat breakfast cereal incorporating the plurality of the base cereal pieces includes processing dough to form pellets, drying the pellets to form dried pellets and forming the dried pellets into cereal base pieces. Forming the dried pellets can include forming the dried pellets into flakes or shredded cereal biscuits. Another method of making ready-to-eat breakfast cereal incorporating the plurality of the base cereal pieces includes processing dough to form an expanded rope and forming the rope into pillow-shaped pieces.

### FIELD OF THE INVENTION

The invention generally pertains to ready-to-eat breakfast cereals and, more particularly, to ready-to-eat breakfast cereals fortified with high-quality protein.

### BACKGROUND OF THE INVENTION

Many consumers want more protein in their diet. A variety of protein fortified ready-to-eat food products including breakfast cereals have been developed. Fortifying breakfast cereals with protein can be challenging, as protein formulations can be sticky, fragile and not amenable to typical cereal piece forming processes such as flaking. Alternatively, or additionally, protein-fortified breakfast cereals can be poor tasting and/or have poor texture.

### SUMMARY OF THE INVENTION

A ready-to-eat breakfast cereal of the invention comprises a plurality of base cereal pieces which are fortified with high quality protein, good tasting and good textured. The base cereal pieces consist of a. a starch-based ingredient in an amount of at least 30% by dry weight of the base cereal pieces; b. a protein ingredient component in an amount sufficient to achieve a protein content of greater than 20% to about 55% by dry weight of the base cereal pieces, the protein ingredient component comprising: i. wheat protein isolate or vital wheat gluten in an amount of about 12% to about 50% by dry weight of the base cereal pieces; and, optionally ii. legume protein concentrate or legume protein isolate in an amount of up to about 20% by dry weight of the base cereal pieces; c. optional oil in an amount of up to about 10% by dry weight of the base cereal pieces; d. an optional bran ingredient in an amount of up to 25% by dry weight of the cereal base pieces; e. no added gums; and f. other ingredients in a total amount of less than 10% by dry weight of the base cereal pieces.

In some embodiments, the other ingredients comprise sugar in an amount of up to 8% by dry weight of the base cereal pieces. The base cereal pieces can be flakes or pillow-shaped and can have a specific density of about 150 to about 400 g per 100 cubic inches. In some embodiments, the base cereal pieces are coated on at least a portion of a surface with a sweetened coating.

A method of making ready-to-eat breakfast cereal comprising a plurality of base cereal pieces is provided, the method including a. processing dough to form pellets having a moisture content of from about 23% to about 32% by weight (e.g., from about 28% to about 32% by weight), wherein the dough consists of a starch-based ingredient in an amount of at least 30% by dry weight of the dough, a protein ingredient component in an amount sufficient to achieve a protein content of greater than 20% to about 55% by dry weight of the dough, the protein ingredient component comprising wheat protein isolate or vital wheat gluten in an amount of about 12% to about 50% by dry weight of the dough and, optionally, legume protein concentrate or legume protein isolate in an amount of up to about 20% by dry weight of the dough, optional oil in an amount of up to about 10% by dry weight of the dough, an optional bran ingredient in an amount of up to 25% by dry weight of the dough, no added gums, and other ingredients in a total amount of less than 10% by dry weight of the dough; b. drying the pellets to form dried pellets having a moisture content of from about 21% to about 26% by weight (e.g., from about 24% to about 26%); and c. forming the dried pellets into cereal base pieces. In some embodiments, the starch-based ingredient has a starch content of 65% to 100% by dry weight. Forming the dried pellets into cereal base pieces can include forming the dried pellets into breakfast cereal flakes or pillow-shaped breakfast cereal. In some embodiments, the method further comprises coating at least a portion of the surfaces of the cereal base pieces with a sweetened coating.

In accordance with another aspect of the invention, a method of making ready-to-eat breakfast cereal comprising a plurality of base cereal pieces is provided, the method including a. processing dough to form a rope having a moisture content of from about 28% to about 32% by weight, wherein the dough consists of a starch-based ingredient in an amount of at least 30% by dry weight of the dough, a protein ingredient component in an amount sufficient to achieve a protein content of greater than 20% to about 55% by dry weight of the dough, the protein ingredient component comprising wheat protein isolate or vital wheat gluten in an amount of about 12% to about 50% by dry weight of the dough and, optionally, legume protein concentrate or legume protein isolate in an amount of up to about 20% by dry weight of the dough, optional oil in an amount of up to about 10% by dry weight of the dough, no added gums, and other ingredients in a total amount of less than 10% by dry weight of the dough; b. forming the rope into pillow-shaped pieces having a moisture content of from about 24% to about 26% by weight; and c. drying the pillow-shaped pieces to a moisture of about 2% to about 4% to make cereal base pieces.

In some embodiments, a method further comprises coating at least a portion of the surfaces of the cereal base pieces with a sweetened coating.

### DETAILED DESCRIPTION

Initially, it should be noted that the embodiments of the present invention described below are not intended to be exhaustive or limit the invention to the precise forms disclosed in the following detailed description. Rather a purpose of the embodiments chosen and described is so that the appreciation and understanding by others skilled in the art of the principles and practices of the present invention can be facilitated.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

A ready-to-eat breakfast cereal in accordance with the present invention comprises a plurality of base cereal pieces which are formulated with ingredients containing high protein without the use of gums to achieve base cereal pieces that are good tasting and good textured. In some embodiments, a base cereal piece in accordance with the present invention consists of whole grain flour, a protein ingredient component, optional oil and other ingredients, but no added gums.

The starch-based ingredient of the base cereal piece is present in an amount of at least 30% by dry weight of the base cereal piece. In some embodiments, the starch-based ingredient is included in an amount of at least 45% by dry weight. In some embodiments, a starch-based ingredient is included in an amount sufficient to provide starch in an amount of at least 15% (e.g., at least 20%) by dry weight of a base cereal piece. The starch-based ingredient includes starch in an amount of about 65% to 100% by dry weight of the starch-based ingredient. Suitable starch-based ingredients can be derived from any edible source, including grains, pulses, tubers, and the like, or any combination of sources, and can include whole flours, refined flours, isolated starches, or any combination thereof. Grain-based flour, and especially whole grain flour are particularly preferred. Whole grain flour can include, e.g., flour from brown rice, wheat, oats, barley, corn, millet, buckwheat, sorghum and/or triticale. In some embodiments, a starch-based ingredient comprises, or consists of, whole grain wheat flour. In some embodiments, the base cereal pieces comprise starch in an amount of at least 25% by dry weight.

The protein ingredient component of the base cereal piece is present in an amount sufficient to achieve a protein content of greater than 20% to about 55% by dry weight of the base cereal piece. In preferred embodiments, the protein ingredient component is present in an amount sufficient to achieve a protein content of greater than 20% to about 52% by dry weight of the base cereal piece. In some embodiments, the protein ingredient component is present in an amount sufficient to achieve a protein content of greater than 20% to about 40% by dry weight of the base cereal pieces. It is to be understood that the protein content in in a base cereal piece includes any protein content contributed by any ingredient in the base cereal piece, including the protein ingredient component, the starch-based ingredient (e.g., whole grain flour), and other ingredients. Protein complementation is the practice of combining different, incomplete plant-based protein sources to provide an adequate amount of all the essential amino acids. The protein ingredient component leverages protein complementation by comprising i. wheat protein isolate or vital wheat gluten and ii. legume protein concentrate or legume protein isolate. Wheat protein isolate or vital wheat gluten is present in an amount of about 12% to about 50% (e.g., about 12% to about 45% or about 12% to about 25%) by dry weight of the base cereal piece. In some embodiments, the legume protein concentrate or legume protein isolate is present in an amount of about 6% to about 20% by dry weight of the base cereal pieces. In some embodiments, the legume protein concentrate is pea protein concentrate or the legume protein isolate is pea protein isolate.

In some embodiments, a ready-to-eat breakfast cereal in accordance with the present invention comprises a plurality of base cereal pieces which are formulated with ingredients containing high quality protein and/or other ingredient sources with complementing amino acids to achieve high quality protein, while maintaining a good tasting and good textured product. “High quality protein” refers to a protein scoring of 1.0 using the PDCAAS method (Protein Digestibility-Corrected Amino Acid Score). Protein complementation is the practice of combining different, incomplete plant-based protein sources to provide an adequate amount of all the essential amino acids. Where the base piece is formulated to contain high quality protein via complementation, the protein ingredient component leverages protein complementation by comprising i. wheat protein isolate or vital wheat gluten and ii. legume protein concentrate or legume protein isolate. Using complementation, some embodiments of base cereal pieces can have at least 4 g (e.g., about 5 g) high quality protein in a 35 g uncoated serving (i.e., at least 8%, or about 10%, high quality protein by dry weight of uncoated cereal pieces). In such embodiments, a legume protein concentrate or legume protein isolate can be present in an amount of at least about 6%. However, if the legume protein concentrate or legume protein isolate is present in an amount greater than about 20%, the base cereal piece is considered to yield a negative eating experience for a consumer.

As used herein, the term “concentrate” when referring to a protein ingredient refers to an ingredient that includes at least 60% (e.g., at least 70%, or at least 80%) protein by dry weight. While commercially available pea protein ingredients that are labeled as “pea protein concentrate” can have a protein concentration of about 40% to about 60% by dry weight, as used herein, a pea protein ingredient having a protein content of at least 60% by dry weight is considered to be a concentrate suitable for use in a base cereal piece. As used herein, the term “isolate” when referring to a protein ingredient refers to an ingredient that includes at least 75% (e.g., at least 80%, or at least 90%) protein by dry weight. For example, a soy protein isolate is typically at least about 85% protein by dry weight; a pea protein isolate is typically about 75% to about 90% protein by dry weight.

The oil in the base cereal piece can be optionally included in an amount of about up to about 10% by dry weight of the base cereal piece. In some embodiments, the oil is included in an amount of about 1% to about 10% by dry weight of the base cereal pieces. In some embodiments, the oil is present in an amount of about 2% to about 8% by dry weight of the base cereal piece.

In some embodiments, a bran ingredient (e.g., wheat bran, oat bran, rice bran, and the like, or any combination thereof) can be included in an amount of up to 25% (e.g., up to 22%, or about 7% up to 22%) by dry weight of a base cereal piece. In some embodiments, the bran ingredient comprises wheat bran in an amount of about 7% to about 22% by dry weight of the base cereal pieces. As used herein, the term bran refers to the outer layers (i.e., aleurone and pericarp) of a cereal grain. Preferably, if a bran ingredient is not included in a base cereal piece, the starch-based ingredient is included in an amount of at least 40% by weight of the base cereal piece.

The base cereal piece of the present invention contains no added gums (e.g., gum acacia). In some conventional cereal pieces, one or more gums (e.g., gum acacia) are included as processing aids for improving processability (e.g., to prevent the cereal piece from breaking apart during process and so the cereal piece maintains structural integrity after processing). It is to be understood that “added gums” does not refer to any gums inherent to a starch-based ingredient, such as arabinoxylans in whole grain flour.

The base cereal piece of the present invention further consists of other optional ingredients in a total amount of less than 10% by dry weight of the base cereal piece. The other ingredients can include ingredients known for use in ready-to-eat breakfast cereals, e.g., sugar, antioxidants, flavorants (e.g., salt, malt), fiber ingredients (e.g., inulin, fructooligosaccharides, galactooligosaccharides, digestive resistant maltodextrin, digestive resistant dextrin, psyllium, polydextrose, digestive resistant starches, and the like), high potency sweeteners, sugar alcohols, inclusions (e.g., cut grain pieces, rice pieces, and the like), tocopherols, malt, polysorbate and/or colorants. In some embodiments, the other ingredients comprise sugar in an amount of up to 8% (e.g., up to about 7%) by dry weight of the base cereal pieces.

In some embodiments, the base cereal piece is in the form of a flake or in the form of a pillow (pillow shaped) or shredded cereal biscuit (e.g., like shredded wheat).

In some embodiments, the base cereal piece has a specific density of about 150 to about 400 g (e.g., about 175 to about 325 g) per 100 cubic inches.

In some embodiments, the base cereal piece is coated on at least a portion of its surface with a sweetened coating.

The present invention is also directed to a method of making ready-to-eat breakfast cereal comprising a plurality of base cereal pieces consisting of a starch-based ingredient, a protein ingredient component, oil and other optional ingredients but no added gums. A method in accordance with the present invention includes a step of processing dough to form pellets or a rope (e.g., an expanded rope) having a moisture content of from about 23% to about 32% (or about 25% to about 32%, or from about 28% to about 32%) by weight. The dough, rope, and/or the pellets consist of a starch-based ingredient, a protein ingredient component, and other optional ingredients but no added gums. The starch-based ingredient is present in an amount of at least 30% by dry weight of the dough. In some embodiments, the starch-based ingredient has a starch content of 65% to 100% by dry weight. In some embodiments, the starch-based ingredient comprises a whole wheat flour. In some embodiments, the dough comprises starch in an amount of at least 25% by dry weight. The protein ingredient component is present in an amount sufficient to achieve a protein content of greater than 20% to about 55% by dry weight of the dough and comprises wheat protein isolate or vital wheat gluten present in an amount of about 12% to about 50% by dry weight of the dough and, optionally, legume protein concentrate or legume protein isolate present in an amount of about up to about 20% by dry weight of the dough. Oil can be optionally included in an amount of up to about 10% by dry weight of the dough. The dough has no added gums. An optional bran ingredient can be present in an amount of up to 25% by dry weight of the dough. In some embodiments, the bran ingredient comprises wheat bran in an amount of about 7% to about 22% by dry weight of the dough. The other optional ingredients can be present in a total amount of less than 10% by dry weight of the dough and can include ingredients used in ready-to-eat-breakfast cereals.

In some embodiments, the step of processing dough includes providing ingredients to a continuous cooker (e.g., providing dry ingredients, liquid ingredients and water and/or steam to the cooker). In some embodiments, the continuous cooker is a twin screw extruder. In some embodiments, dry ingredients (e.g., the whole grain flour and the protein ingredient component) are added to the extruder at a rate of about 2.5 to 4.5 pounds per minute, water is pumped into the extruder at a flow rate of about 0.6 to 1.0 pounds per minute, and/or liquid ingredients (e.g., oil, malt, or the like) are pumped into the extruder at a flow rate of about 0.2 to 0.6 pounds per minute. The combined ingredients are blended (to form the dough) and cooked in a barrel of the extruder. In some embodiments, the barrel includes screws for blending the ingredients and forcing the combined mass through zones of the extruder (e.g., three zones). A first zone, or feed zone, of the extruder can be at ambient temperature while other, subsequent zones can reach one or more temperatures of up to about 300-320° F. In some embodiments, the extruder employs a pressure of about 750 psi in one or more zones.

The screws of the extruder force the cooked dough through the barrel and through a die of the extruder, which can operate at a die pressure of about 400 to 800 psi. In some embodiments, the cooked dough has a temperature in the range of 250 to 300° F. at the die orifice.

In some embodiments, the continuous cooker is a heated paddle cooker to which dry ingredients (e.g., the whole grain flour and the protein ingredient component) are added to the cooker at a rate of about 20 to about 30 pounds per minute, water is pumped into the cooker at a flow rate of about 6 to about 12 pounds per minute, and/or liquid ingredients (e.g., oil, malt, and the like) are pumped into the cooker at a flow rate of about 0.4 to 0.6 pounds per minute. The combined ingredients are blended (to form the dough) and cooked in a barrel of the cooker. In some embodiments, the barrel includes paddles for blending the ingredients and forcing the combined mass through the cooker, which is heated to about 200° F. to about 300° F. In some embodiments, the dough residence time in the cooker is about 30 to about 45 minutes, and the cooker employs a power of about 55 kW.

The paddles of the cooker force the cooked dough through the barrel and through a die of the cooker, and the cooked dough has a temperature in the range of 190 to 230° F. at the die.

In some embodiments, the cooked dough can be extruded from the extruder in the form of a plurality of expanded ropes. In some embodiments, the dough can be co-extruded so that the rope contains an inner material. Suitable inner materials include, for example, a filling, or air that can create a hollow pocket to create a lower density and/or an airy texture. An expanded cooked dough rope can be crimped and cut directly from the extruder. Or, in some cases, cooked dough is extruded into a pipe to extend cooking and/or to cool the dough to reduce expansion of the ropes. Although some expansion in the ropes of cooked dough can still occur, the ropes of cooked dough remain denser than direct expanded, puffed cereal pieces.

In some embodiments, the expanded ropes (e.g., extruded expanded ropes from the die of the extruder) can be formed into pillow-shaped pieces (pillows). In some embodiments, the expanded ropes are formed into pillows by crimping and/or cutting the rope along its length. In some cases, the rope can be co-extruded so that the rope contains an inner material, encased by the dough upon crimping. This could be a filling or air to achieve a lower density and/or airy texture. In some embodiments, the pillow-shaped pieces (pillows) can then be dried (e.g., in an oven) (e.g., at about 230° F.) to a moisture content of about 2% to about 4% to produce cereal base pieces.

In some embodiments the extruded ropes can be transferred with minimal expansion from the die of the extruder to an extension pipe or to a cold forming extruder to form non-expanded pellets. By way of example, in some embodiments, the extruded ropes enter the cold forming extruder at a temperature of 180° F. to 220° F. In some embodiments, the cold forming extruder operates at a temperature of 100° F. to 150° F. and/or includes screws operating at a speed of 10 to 80 (e.g., 60 to 70) rpm forcing the ropes through former. The cooked cold formed ropes exit a die of the cold pellet former with limited expansion. In some embodiments, the die of the cold forming extruder has a temperature of 150° F. to 175° F. The cold forming extruder includes a blade passing across the die, cutting the cooked ropes into a plurality of non-expanded pellets. In some embodiments, the blade operates at a speed of 70 to 110 rpm, and the rope is cut into a plurality of pellets having a weight of 30 to 40 grams per 100 pellets. The non-expanded pellets have a moisture content of from about 23% to about 32% (or about 25% to about 32%) by weight. Next, the method further includes a step of drying the pellets to form dried pellets having a moisture content of lower than 28% by weight. Dried pellets having a moisture content lower than about 21% (e.g., lower than about 24%) by weight can cause issues in later processing steps (e.g., too much puffing and/or improper feeding for flaking). In some embodiments, dried pellets can also be cooled.

Dried pellets can then be formed into cereal base pieces. In some embodiments, forming the dried pellets into cereal base pieces includes forming the dried pellets into shredded cereal biscuits. Generally, to make shredded cereal biscuits, dried pellets are fed into shredding rolls to form a shredded layer, and shredded layers are stacked 3 or more (e.g., 3 to 25) layers high to form a shredded sheet. The shredded sheet can then be crimped and/or cut into shredded cereal biscuits. Shredded cereal biscuits can then be further dried and/or baked.

In some embodiments, forming the dried pellets includes flaking the dried pellets (forming the dried pellets into flakes). It is important the pellets are dried before flaking to prevent the pellets from clumping during flaking. The dried pellets are added to a flaking mill, such as a conventional flaking mill used to form conventional ready-to-eat cereal flakes. In preferred embodiments, the dried pellets are at a temperature of about 110° F. to 130° F. when added to the flaking mill. The flaking mill is used to press the pellets into cereal flakes (i.e., each pellet is pressed into the form of a flake). In some embodiments, the cereal flakes are then dried and/or toasted in, e.g., a conventional hot air impingement type oven to a moisture content of about 1 to 5 wt %.

The method can further include a step of applying a coating to at least a portion of surfaces of the cereal base pieces (e.g., via a coating process used for conventional ready-to-eat cereals).

### EXAMPLES

Examples A-D—Percentages of whole grain flour and protein ingredient components relative to the combined weight of the whole grain flour and protein ingredient components.

| | | Vital | Wheat | Pea | Pea |
|---|---|---|---|---|---|
| | Wheat | Wheat | Protein | Protein | Protein |
| | flour | Gluten | Isolate | Concen- | Isolate |
| | (%) | (%) | (%) | trate (%) | (%) |
| Example A | 69 | 24 | — | — | 7 |
| Example B | 70 | — | 24 | — | 6 |
| Example C | 71 | 12 | — | 17 | — |
| Example D | 39 | 39 | | 10 | |

1. A ready-to-eat breakfast cereal, comprising a plurality of base cereal pieces, the base cereal pieces consisting of:
a. a starch-based ingredient having a starch content of 65% to 100% by dry weight, the starch-based ingredient included in an amount of at least 30% by dry weight of the base cereal pieces;
b. a protein ingredient component in an amount sufficient to achieve a protein content of greater than 20% to about 55% by dry weight of the base cereal pieces, the protein ingredient component comprising:
i. wheat protein isolate or vital wheat gluten in an amount of about 12% to about 50% by dry weight of the base cereal pieces; and
ii. legume protein concentrate or legume protein isolate in an amount of up to about 20% by dry weight of the base cereal pieces;
c. oil in an amount of up to about 10% by dry weight of the base cereal pieces;
d. a bran ingredient in an amount of up to 25% by dry weight of the base cereal pieces;
e. no added gums; and
f. other ingredients in a total amount of less than 10% by dry weight of the base cereal pieces.

2. The cereal of claim 1, wherein the starch-based ingredient is included in an amount of at least 45% by dry weight.

3. The cereal of claim 1, wherein the protein ingredient component is included in an amount sufficient to achieve a protein content of greater than 20% to about 40% by dry weight of the base cereal pieces, the protein ingredient component comprising:
i. wheat protein isolate or vital wheat gluten in an amount of about 12% to about 25% by dry weight of the base cereal pieces; and
ii. legume protein concentrate or legume protein isolate in an amount of about 6% to about 20% by dry weight of the base cereal pieces.

4. The cereal piece of claim 1, wherein the oil is included in an amount of about 1% to about 10% by dry weight of the base cereal pieces.

5. The cereal of claim 1, wherein the other ingredients comprise sugar in an amount of up to 8% by dry weight of the base cereal pieces.

6. The cereal of claim 1, wherein the cereal pieces are flakes.

7. The cereal of claim 1, wherein the cereal pieces are pillow shaped or shredded cereal biscuits.

8. The cereal of claim 1, wherein the base cereal pieces have a specific density of about 150 to about 400 g per 100 cubic inches.

9. The cereal of claim 1, wherein the legume protein concentrate is pea protein concentrate or the legume protein isolate is pea protein isolate.

10. The cereal of claim 1, wherein the starch-based ingredient comprises a whole grain flour.

11. The cereal of claim 1, wherein the base cereal pieces comprise starch in an amount of at least 25% by dry weight.

12. The cereal of claim 1, wherein the bran ingredient comprises wheat bran in an amount of about 7% to about 22% by dry weight of the base cereal pieces.

13. A method of making ready-to-eat breakfast cereal comprising a plurality of base cereal pieces, the method comprising
a. processing dough to form pellets having a moisture content of from about 23% to about 32% by weight, wherein the dough consists of:
i. starch-based ingredient in an amount of at least 30% by dry weight of the dough, the starch-based ingredient having a starch content of 65% to 100% by dry weight,
ii. a protein ingredient component in an amount sufficient to achieve a protein content of greater than 20% to about 55% by dry weight of the dough, the protein ingredient component comprising wheat protein isolate or vital wheat gluten in an amount of about 12% to about 50% by dry weight of the dough and legume protein concentrate or legume protein isolate in an amount of up to about 20% by dry weight of the dough,
iii. oil in an amount of up to about 10% by dry weight of the dough,
iv. no added gums,
v. a bran ingredient in an amount of up to 25% by dry weight of the dough; and
vi. other ingredients in a total amount of less than 10% by dry weight of the dough;
b. drying the pellets to form dried pellets having a moisture content of from about 21% to about 26% by weight; and
c. forming the dried pellets into cereal base pieces.

14. The method of claim 13, wherein forming the dried pellets into cereal base pieces includes forming the dried pellets into flakes and drying the flakes.

15. The method of claim 13, wherein forming the dried pellets into cereal base pieces includes forming the dried pellets into shredded cereal biscuits.

16. The method of claim 13, wherein the other ingredients comprise sugar in an amount of up to 8% by dry weight of the dough.

17. The method of claim 13, wherein the dough comprises starch in an amount of at least 25% by dry weight.

18. The method of claim 13, wherein the starch-based ingredient comprises a whole wheat flour.

19. The method of claim 13, wherein the bran ingredient comprises wheat bran in an amount of about 7% to about 22% by dry weight of the dough.

20. A method of making ready-to-eat breakfast cereal comprising a plurality of base cereal pieces, the method comprising
a. processing dough to form an expanded rope having a moisture content of from about 28% to about 32% by weight, wherein the dough consists of:
i. starch-based ingredient in an amount of at least 30% by dry weight of the dough, the starch-based ingredient having a starch content of 65% to 100% by dry weight,
ii. a protein ingredient component in an amount sufficient to achieve a protein content of greater than 20% to about 55% by dry weight of the dough, the protein ingredient component comprising wheat protein isolate or vital wheat gluten in an amount of about 12% to about 50% by dry weight of the dough and legume protein concentrate or legume protein isolate in an amount of up to about 20% by dry weight of the dough,
iii. oil in an amount of up to about 10% by dry weight of the dough,
iv. no added gums,
v. a bran ingredient in an amount of up to 25% by dry weight of the base cereal pieces; and
vi. other ingredients in a total amount of less than 10% by dry weight of the dough;
b. forming the expanded rope into pillows; and
c. drying the pillows to a moisture of about 2% to about 4% to produce cereal base pieces.
